(19) United States
(12) Patent Application Publication
(10) Pub. No.: US 2008/0254960 A1
(43) Pub. Date: Oct. 16, 2008

(54) Cylinders for Machines that Process Continuous Lengths of Material

(76) Inventor: Michael Rolf Thiemicke, Landau (DE)

Correspondence Address: Douglas R. Hanscom;Jones, Tullar & Cooper, P.C., P.O. Box 2266, Eads Station, Arlington, VA, 22202, US

(21) Appl. No.: 11/630,675

(22) PCT Filed: Jun. 3, 2005
(86) PCT No.: PCT/EP2005/052557

§ 371 Date: Dec. 26, 2006

(30) Foreign Application Priority Data
Jun. 25, 2004 (DE) 10 2004 030 702.4

(51) Int. Cl. F16C 13/00

(52) U.S. Cl. 492/15

(57) ABSTRACT

A cylinder which is part of a machine which processes lengths of material includes a rotationally fixed central pin or shaft. A casing or jacket is rotatably supported on the central pin or shaft by a number of bearings. A sleeve can be placed over the outer surface of the jacket or casing. A lubricant space, which extends, in sections, in an axial direction, is located between the pin or shaft and an inner surface of the jacket or casing. A compressed gas space which extends, in sections, in an axial direction, is provided with outlet openings on an outer surface of the jacket or casing.

### CROSS-REFERENCE TO RELATED APPLICATIONS

This application is the U.S. national phase, under 35 USC 371, of PCT/EP2005/052557, filed Jun. 3, 2005; published as WO 2006/000516 A1 on Jan. 5, 2006; and claiming priority to DE 10 2004 030 702.4, filed Jun. 25, 2004, the disclosures of which are incorporated herein by reference.

### FIELD OF THE INVENTION

The present invention is directed to cylinders for machines that process continuous lengths of material. The cylinder includes a non-rotating shaft or axle and a casing or jacket which is rotatably supported by a plurality of bearings on the shaft. A sleeve can be slid onto the casing or jacket.

### BACKGROUND OF THE INVENTION

The basic structure of a cylinder of this general type, which type of cylinder is preferably used in gravure printing presses, can be taken, for example, from EP 0 047 435 B1. In this publication, the principal arrangement of the impression cylinder in a gravure printing press is also described. Options are also presented which allow the impression cylinder to be bent in adjustment to a line of bending of the printing cylinder which is opposite to it. One particular difficulty of known cylinder configurations consists in effectively lubricating and, if necessary, in also effectively cooling the bearings and other movable parts of the impression cylinder, while at the same time providing a suitable structure for facilitating the pulling of various sleeves onto the outer casing or jacket of the impression cylinder.

A cylinder for use in machines that process continuous lengths of material is known from EP 0 179 363 B1. This cylinder comprises a non-rotatably mounted spindle and a tubular casing, which casing is rotatably mounted on the underlying spindle. The casing of the impression cylinder is made, for example, of steel and bears a sheathing, or covering, which is also called a sleeve, of rubber-like material. At high printing speeds, and thus at high rates of rotation of the cylinder, the flexing work that is performed causes a substantial warming of the sleeve. To efficiently draw off the heat that is produced by this flexation, the cylinder which is described in this prior art document uses a heat exchanger, which is integrated into the cylinder. However, this results in a complicated, and a maintenance-intensive configuration of the cylinder. The particular problems of a simultaneously efficient lubrication of the movable parts of the cylinder cannot be solved by the provision of an integrated heat exchanger.

In WO 01/85454 A1 a cylinder is shown, in which a lubricant circuit and cooling circuit is constructed. For effective lubrication, and for simultaneous cooling of all of the cylinder movable elements, a fluid flow is generated inside the cylinder, and especially in the space between a stationary support for the cylinder and the tubular casing. However, further difficulties arise with the sealing of the flow area at high rotational speeds and with a desirable optional bending of the cylinder. Furthermore, this prior art configuration provides no solution as to how the exchange of the sleeve to be applied to the casing of the cylinder can be facilitated and/or supported. The conventional use of a running-in layer which is generated on the casing using compressed air is excluded in this prior art cylinder because the lubricant circuit that is provided in the cylinder no longer allows the compressed air to flow out through the cylinder casing.

### SUMMARY OF THE INVENTION

The object of the present invention is to provide cylinders for machines that process continuous lengths of material.

The object is attained in accordance with the present invention with the provision of a cylinder that includes a non-rotatable shaft or axle and a casing or jacket that is rotatably supported on the shaft or axle using a plurality of bearings. A flexible sleeve can be slid over the casing or jacket. A lubricant chamber is provided between the shaft and the casing or jacket and extends, in sections, in an axial direction. A compressed gas chamber, with outlet openings, and which extends in a cylinder axial direction, is provided on the casing. The lubricant chamber and the compressed gas chamber may be in fluid communication with lubricant channels and gas bores in the shaft.

The benefits to be achieved with the present invention consist especially in that with this cylinder, both an effective lubrication of the movable components and an easy exchange of the sheathing or sleeve is possible using compressed air.

With the adjacent arrangement of two sealing rings, the sealing edges of which are turned away from one another, and which sealing edges thus are respectively turned toward the lubricant chamber on one side and toward the compressed gas chamber on the other side, an improved sealing between these two chambers, which conduct different media, is achieved. It is thereby ensured that no lubricant can be lost via the compressed gas chamber, nor can any lubricant escape with the compressed gas from the cylinder. The two sealing rings can be made of different materials and can have different shapes, thereby allowing them to each be optimally adjusted to the respective medium contained in the chamber being sealed by each such sealing ring.

It is particularly advantageous for the compressed gas chamber to be supplied with compressed gas, and especially with compressed air, via a compressed gas bore that extends at least partially in the shaft. A compressed gas supply line can be particularly easily connected at the end-surface opening of the compressed gas bore in the non-rotating shaft. Starting from the compressed gas bore extending in the shaft, multiple supply bores can lead from that bore to the compressed gas chamber.

To accomplish an efficient lubrication of the bearing, and to accomplish a simultaneous adequate cooling of the cylinder casing, it is advantageous for the lubricant, such as, for example, oil, to be brought to a specific volume rate of flow during the rotation of the casing. The heat that is generated by the flexing action of the sleeve or the jacket or casing can be rapidly drawn off from the interior side of the casing. Furthermore, the lubricant flow can preferably extend through the individual bearings, which bearings are arranged between the shaft and the casing, in order to ensure optimal lubrication conditions there as well. Because the individual bearings each acts to inhibit a free flow of lubricant in an axial direction, the lubricant must be purposely accelerated in an axial direction. Once the lubricant has passed through such a bearing, it must also be returned to the starting side of the chamber. For this purpose, it is advantageous to pass a lubricant channel through the shaft, and extending at an angle with respect to the longitudinal or axial direction of the shaft, with the ends of the lubricant channel lying in areas of the lubricant chamber that are separated from each other by the bearing that is to be lubricated.

To purposely accelerate the lubricant, so that it is able to pass through a rotating bearing, and particularly through roller bearing which is the type of bearing being especially used here, an oil deflector, which is arranged at an angle, is preferably positioned near the interior surface of the casing. When the casing is rotated, this first oil deflector scrapes off the oil which has been adhering to the interior surface of the casing, and accelerates it in an axial direction. It is also advantageous for a second oil deflector to be provided, which second oil deflector, once the stream of lubricant has passed through a bearing, diverts that stream, which is initially running in an axial direction, essentially to a radial direction, to both complete the lubricant circuit and to minimize the oil pressure that is acting on the sealing ring on the lubricant side. To accomplish this result, the second oil deflector is preferably positioned very close to the lubricant-side sealing ring.

### BRIEF DESCRIPTION OF THE DRAWINGS

One preferred embodiment of the cylinder in accordance with the present invention is depicted in the set of drawings and will be described in greater detail below.

The drawings show in

FIG. 1 a cross-sectional top plan view of a cylinder in accordance with the present invention, wherein only individual sections of the cylinder are shown; in

FIG. 2 a cross-sectional, detailed representation of two sections of the cylinder, the cutting plane of FIG. 2 extending axially parallel with, but perpendicular to the cutting plane of FIG. 1; and in

FIG. 3 a variation of the two sections of the cylinder shown in FIG. 2.

### DESCRIPTION OF THE PREFERRED EMBODIMENT

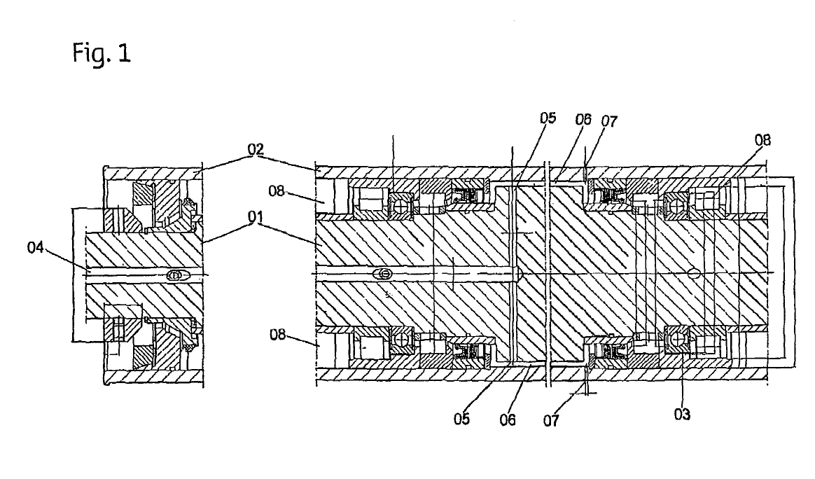

As may be seen by initially referring to the longitudinal cross-section representation of a first preferred embodiment of the present invention, as seen in FIG. 1, an impression cylinder or a cylinder generally comprises a shaft 01 that may be structured either as a single piece or as multiple pieces. Shaft 01 is non-rotatably mounted with one end in a fixed bearing and the other end in an axially or radially movable bearing, which is not specifically shown. A printing machine, in which the cylinder of the present invention is intended for use, is preferably a gravure printing press, in which the cylinder, which may be an impression cylinder, acts as a printing cylinder or as a forme cylinder for printing on a substrate. The cylinder, and especially a sleeve that is positioned on the cylinder, can also have one or more printing formes on its circumferential surface. The second principal component of the cylinder, in addition to the shaft 01, is a tubular casing or jacket 02, which is rotatably mounted on the shaft 01. Multiple bearing assemblies 03 are used to rotatably mount the casing 02 on the shaft. These bearing assemblies, and are preferably structured as ball bearing assemblies or as similar roller bearing.

A compressed gas inlet bore 04 extends, axially in shaft 01 in the first preferred embodiment depicted in FIG. 1, and beginning at the fixed bearing end of the shaft 01, or on the left, as seen in FIG. 1. The compressed gas inlet bore 04 extends axially to preferably multiple compressed gas supply bores 05, which extend essentially radially through the shaft 01, with each such radial bore 05 opening up into a compressed gas chamber 06. The compressed gas chamber 06 in turn communicates with multiple compressed gas outlet openings 07, which are distributed around the outer circumferential periphery of the casing or jacket 02. When a sheathing or sleeve that is not specifically shown in the drawings, is applied to the outer circumference of the casing or jacket 02, compressed air is forced out of the compressed gas outlet openings 07 from the compressed gas chamber 06, thus making it easier to pull the sleeve onto the casing or jacket 02 or to remove the sleeve from the casing or jacket 02.

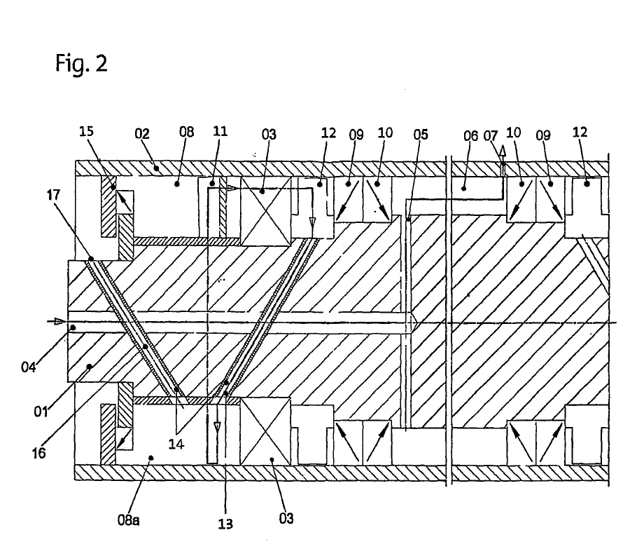

In each of the end areas of the cylinder, a lubricant chamber 08 is provided for lubricating the bearings 03 and the rotatable casing or jacket 02. As is shown more clearly in FIG. 2, lubricant chamber 08 is extending in an axial direction, in sections, between the shaft 01 and an interior wall of the casing or jacket 02. A suitable lubricant, especially oil, is held inside the lubricant chamber 08.

Referring now particularly to the detailed drawing of the cylinder in accordance with the present invention, as presented in FIG. 2, the structural details of the cylinder can be seen in greater detail. The flow of compressed air, which may be introduced into the compressed gas bore 04 at, for example, a pressure of 15 bar, is indicated by a bold, dot-dashed line. The compressed air flow runs through the compressed gas inlet bore 04 and the connected compressed gas supply bore 05 into the compressed gas chamber 06, and from there through the outlet openings 07 in the casing or jacket 02 to the outside circumferential peripheral surface of the casing or jacket 02.

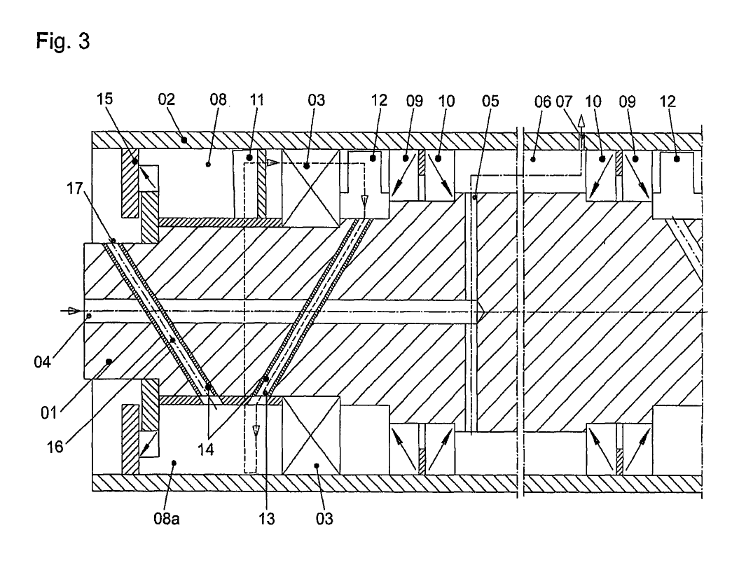

To achieve an effective, sealed separation between the compressed gas chamber 06 and the lubricant chamber 08, these two chambers are separated from one another by a lubricant-side sealing ring 09 and by a compressed gas-side sealing ring 10, as may be seen in FIG. 2. The two sealing rings 09; 10 are preferably both annular rings which are arranged, for example, directly adjacent to one another, as seen in FIG. 2, and are each preferably made of a material that is suited to the medium which is contained in the adjacent chamber, typically either oil or compressed air. Furthermore, the adjacent cooperating pairs of sealing rings 09; 10 are each positioned as close as possible to one of the bearings 03 on which the casing or jacket 02 is supported. The various mechanical stresses which act on the sealing rings 09; 10, and that result from the possible bending of the impression cylinder casing can be kept low by the placement of these sealing rings 09; 10 adjacent the bearing assemblies 03. The sealing edges of the respective sealing rings 09; 10 are each turned toward the respective bordering lubricant chamber 08 or compressed gas chamber 06, as is indicated by the arrows shown in the sealing rings 09; 10 depicted in FIGS. 2 and 3. In this manner, a separate sealing of the lubricant chamber 08 and of the compressed gas chamber 06 is accomplished, so that the corresponding stress acts on only one side, on the respective sealing ring 09; 10. In this manner, an effective sealing of each of the two chambers 06; 08 can be achieved over a substantially longer period of time as compared with the sealing of the two chambers 08; 06 which could be accomplished by the use of a single, common sealing ring 09 or 10 for the two chambers 08; 06, which single, common sealing ring would then be stressed from both sides by different media.

In a second preferred embodiment of the present invention, which is shown in FIG. 3, a spacer ring is positioned between the lubricant-side sealing ring 09 and the compressed gas-side sealing ring 10 to form an oil chamber between the lubricant-side sealing ring 09 and the compressed gas-side sealing ring 10. This oil chamber is for the purpose of lubricating the compressed gas-side sealing ring 10.

To achieve an efficient lubrication in the lubricant chamber 08, during the rotation of the casing or jacket 02, a directed lubricant flow is accomplished as follows. In an idle state of the cylinder, the lubricating oil collects in the lower portion 8a of the lubricant chamber 08, as seen in FIG. 2. When the casing or jacket 02 is rotated, a layer of oil forms on an interior surface of the casing or jacket 02, which oil layer has a certain thickness, with that thickness depending primarily upon the speed of rotation of the casing or jacket 02 and the viscosity of the oil. To also direct the lubricating oil through the bearing 03, a first, outer oil deflector 11 is located in the lubricant chamber 08. This first, outer oil deflector 11 scrapes off part of the layer of oil that has adhered to the interior surface of the casing 02. The first, outer oil deflector 11 is positioned at a slight angle with respect to a diametral plane extending through the casing or jacket 02, in order to accelerate the scraped off oil in the axial direction of the cylinder. The resulting flow of lubricant is represented by a dashed line in FIG. 2. Because the first, outer oil deflector 11 is located in the lubricant chamber 08 near the bearing 03, the lubricant flow is directed axially through the bearing 03, as seen in FIG. 2. Axially interiorly of the bearing 03, in the direction of oil flow, as seen in FIG. 2, a radial oil layer again forms on the interior surface of the casing 02 in an axially interior lubricant chamber which is defined by the bearing assembly 03 and the lubricant-side sealing ring.

To keep the pressure of the oil acting on the lubricant-side sealing ring 09 low, a second, inner oil deflector 12 is provided in the interior lubricant chamber, which second, inner oil deflector 12 scrapes the lubricating oil off of the interior surface of the casing 02 and directs it toward the shaft 01.

In the embodiment of the present invention which is depicted in FIGS. 2 and 3, the lubricant circuit is completed by a lubricant channel 13, which extends generally diametrically through the shaft 01 and at an angle in relation to the axial direction of the cylinder. In this depicted configuration, the two ends of the lubricant channel 13 open into the interior and outer or exterior sections of the lubricant chamber 08 that are separated by the bearing 03. The oil passes through the lubricant channel 13, by the force of gravity, from the rear or interior side of the bearing 03 back to the front or exterior or outer side of the bearing 03, where it is redistributed over the interior surface of the casing 02 by the force of the rotation of the casing 02.

Because the lubricant channel 13 extends through the center of the shaft 01, and thus is intersecting with the axially centrally located compressed gas bore 04, a seal must be provided between the lubricant channel 13 and the compressed gas bore 04. This is accomplished, for example, by inserting a tube 14 into a corresponding bore in the shaft 01. It would also be within the scope of the present invention for the lubricant channel 13 to extend offset radially, in relation to the compressed gas bore 04, thereby avoiding an intersection of these two hollow conduits.

To seal the outer side of lubricant chamber 08 toward the outside of the cylinder, additional end sealing elements 15 are provided in the end areas of the cylinder. To be able to fill the oil into the lubricant chamber 08 and to be able to measure the oil fill level, an oil fill bore 16 that is accessible from the outside of the cylinder is provided. This oil fill bore 16 extends, for example, through the shaft 01. It must also be sealed by a tube 14 if it intersects with the compressed gas bore 04. The oil fill bore 16 extends from an oil fill opening 17, at the exterior of the shaft 01, to the lubricant chamber 08. The oil fill bore 16 can also be used to vent the lubricant chamber 08. In addition, an oil level gauge, which is not specifically shown can be inserted into the oil fill bore 16 and, with which oil level gauge the oil fill level of the lubricant chamber 08 can be checked.

It should be noted that, in accordance with the present invention and based upon the intended use of the cylinder, multiple lubricant chambers 08 and, as needed, multiple compressed gas chambers 06 can be constructed in the cylinder. These lubricant chambers 08 and gas chambers 06 would be configured and sealed against one another in a comparable manner, as has been described above.

While preferred embodiments of cylinders of machines that process continuous lengths of material, in accordance with the present invention, have been described fully and completely hereinabove, it will be apparent to one of skill in the art that various change in, for example, the type of sleeve positionable on the cylinder casing or jacket, the source of the compressed gas, and the like could be made without departing from the true spirit and scope of the present invention which is accordingly to be limited only by the appended claims.

What is claimed is:

1-34. (canceled)

35. A cylinder adapted for use in a machine that is usable for processing lengths of material, said cylinder comprising:
a non-rotatable shaft having a longitudinal shaft axis;
a casing supported for rotation on said shaft and adapted to receive a sleeve on a casing circumferential surface;
spaced bearing assemblies between an outer surface of said shaft and an inner surface of said casing;
a lubricant channel in said shaft; and
a compressed gas bore in said shaft.

36. The cylinder of claim 35 further including at least one lubricant chamber between said shaft and said casing and divided axially into lubricant chamber sections, at least one compressed gas chamber between said shaft and said casing and divided axially into compressed gas chamber sections, and compressed gas outlet openings extending from said compressed gas chamber sections to said casing circumferential surface.

37. The cylinder of claim 36 further including at least one lubricant-side sealing ring and one compressed gas-side sealing ring separating each said lubricant chamber and an adjacent compressed gas chamber.

38. The cylinder of claim 37 wherein each said sealing ring has a sealing edge and an annular sealing body extending radially between said shaft and casing inner surface, each said sealing edge facing its respective one of said lubricant chamber and said compressed gas chamber.

39. The cylinder of claim 36 wherein said at least one compressed gas chamber is supplied with a gas under pressure through said compressed gas bore.

40. The cylinder of claim 35 further including a shaft axial end with a compressed gas bore inlet at said shaft axial end.

41. The cylinder of claim 39 further including at least one radially extending compressed gas supply bore extending between said compressed gas bore and said compressed gas chamber.

42. The cylinder of claim 35 further including at least one lubricant chamber between said shaft and said casing and divided into lubricant chamber sections by one of said spaced bearing assemblies, said at least one lubricant channel extending between said lubricant chamber sections divided by said bearing assembly.

43. The cylinder of claim 42 wherein said at least one lubricant channel extends through said shaft at an angle with respect to said shaft longitudinal axis.

44. The cylinder of claim 43 further wherein said at least one lubricant channel intersects said compressed gas bore and is seated in an airtight manner with respect to said compressed gas bore.

45. The cylinder of claim 44 wherein said at least one lubricant channel is a tube in a through bore located in said shaft.

46. The cylinder of claim 36 further including at least a first oil deflector in each said lubricant chamber.

47. The cylinder of claim 46 wherein said at least first oil deflector is located adjacent an inner surface of said casing and adjacent said one of said bearings located in said lubricant chamber.

48. The cylinder of claim 47 wherein said at least first oil deflector is angled whereby oil removed from said inner surface of said casing, during rotation of said casing, is accelerated axially by said at least first oil deflector in a direction of said bearing.

49. The cylinder of claim 46 further including a second oil deflector in each said lubricant chamber.

50. The cylinder of claim 49 further including a lubricant-side sealing ring defining a portion of said lubricant chamber and wherein said second oil deflector is arranged near an inner surface of said casing and adjacent said lubricant-side sealing ring.

51. The cylinder of claim 50 wherein a first end of said lubricant channel ends in said lubricant chamber adjacent said first oil deflector and a second end of said lubricant channel ends in said lubricant chamber adjacent said second oil deflector.

52. The cylinder of claim 50 wherein said second oil deflector is between said bearing and said lubricant-side sealing ring.

53. The cylinder of claim 36 wherein said at least one lubricant chamber is located axially adjacent an end of said cylinder and said at least one compressed gas chamber is located axially centrally in said cylinder.

54. The cylinder of claim 36 wherein said bearings are roller bearings in said lubricant chamber.

55. The cylinder of claim 37 wherein said lubricant-side sealing ring is made of a first material and said compressed gas-side sealing ring is made of a second material which is different from said first material.

56. The cylinder of claim 37 wherein each said lubricant-side sealing ring is located adjacent one of said spaced bearing assemblies.

57. The cylinder of claim 37 further including a spacer ring between said lubricant-side sealing ring and said compressed gas-side sealing ring and usable to allow lubricant flow to said compressed gas-side sealing ring.

58. The cylinder of claim 36 further including an oil fill bore in said shaft and extending from an oil fill opening to said at least one lubricant chamber.

59. The cylinder of claim 58 wherein said oil fill bore extends through said shaft at an angle with respect to said longitudinal shaft axis.

60. The cylinder of claim 58 wherein said oil fill bore acts as a lubricant chamber vent opening.

61. The cylinder of claim 58 further including an oil level gauge insertable in said oil fill bore.

62. The cylinder of claim 35 wherein said cylinder is an impression cylinder of a printing machine.

63. The cylinder of claim 35 wherein said cylinder is a printing cylinder.

64. The cylinder of claim 35 wherein a sleeve positionable on said casing is a printing forme.

65. The cylinder of claim 35 wherein said cylinder is arranged in a printing press.

66. The cylinder of claim 35 wherein said cylinder is arranged in a gravure printing press.
